(19) United States
(12) Patent Application Publication
(10) Pub. No.: US 2007/0035120 A1
(43) Pub. Date: Feb. 15, 2007

(54) Bible notebook pouch

(76) Inventor: Darrell Jerome Payne, Long Beach, CA (US)

Correspondence Address: DARRELL JEROME PAYNE, 920 E NEW YORK, LONG BEACH, CA, 90813, US

(21) Appl. No.: 11/080,620

(22) Filed: Aug. 15, 2005

(51) Int. Cl. B42D 3/00

(52) U.S. Cl. 281/31

(57) ABSTRACT

It is a custom made pouch that is attached to the front cover of a Bible or text book. It is created to be an enclosed storage compartment for a tablet and other record keeping products. The pouch has an extended piece of material at the bottom of the pouch that extends downwards, wraps around the spine of the Bible to the back cover; two straps are positioned at the end of the extended piece of material. The two straps are design to wrap around to the inside of the back cover and connect together with Velcro material.

### SUMMARY OF THE PRESENT INVENTION

A custom made-pouch that is fitted to slide onto the outside cover of most Bibles and books.

### THE DESIGN

The pouch consist of two pieces of material sewn together. It provides storage of a notebook, a notepad, or note tablet in addition to pens and pencils.

The pouch is attached to a sleeve which slides onto the front cover of the Bible and book. The material acts as a sleeve that overlaps for the purpose of connected to secure in place by Velcro material.

An extended piece of material is attached to the bottom of the pouch. It wraps around the spine to the back cover about 1½″.

Two straps are attached to the extended piece of material. These straps wrap around the back cover and fold on the inside and are connected with Velcro.

The pouch will fit Bibles and books with measurements of 8¾″ by 5½″, 9¾″ by 6½″, and 10¼″ by 6½″.

The three sizes are the most popular, yet the pouch can be customized to accommodate other books.

The pouch consist of a compartment or slot with an opening at the top. There are three ways to close the pouch:
A. The pouch has a fold-over flap that overlaps to close the opening. The flap is fastened with a metal snap button.
B. The pouch has a fold-over flap that overlaps to close the opening. The flap is fastened with Velcro material.
C. The pouch has a plastic zipper at the top of the opening.

The pouch will fit hard cover and paperback books; bonded and leather cover.

### DETAILED DESCRIPTION OF THE INVENTION

The following description of the representation version of the pouch is presented to illustrate the present invention and is not to be construed to limit the scope of the appended claims in any manner whatsoever.

### THE FUNCTION OF THE POUCH DEFINED

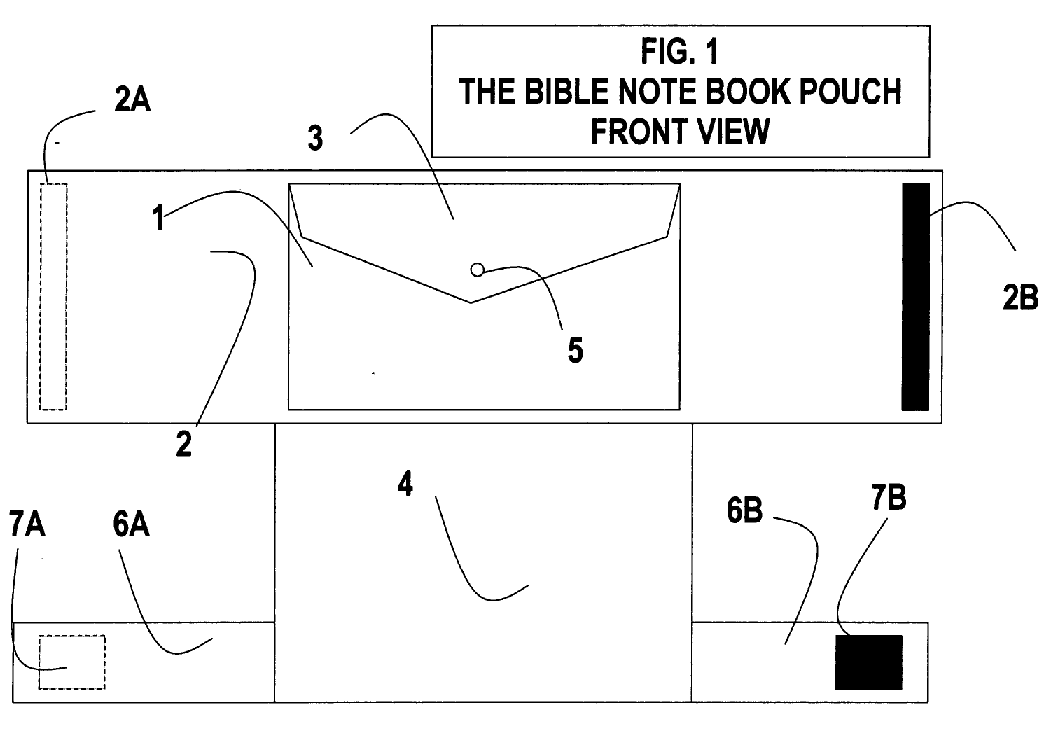

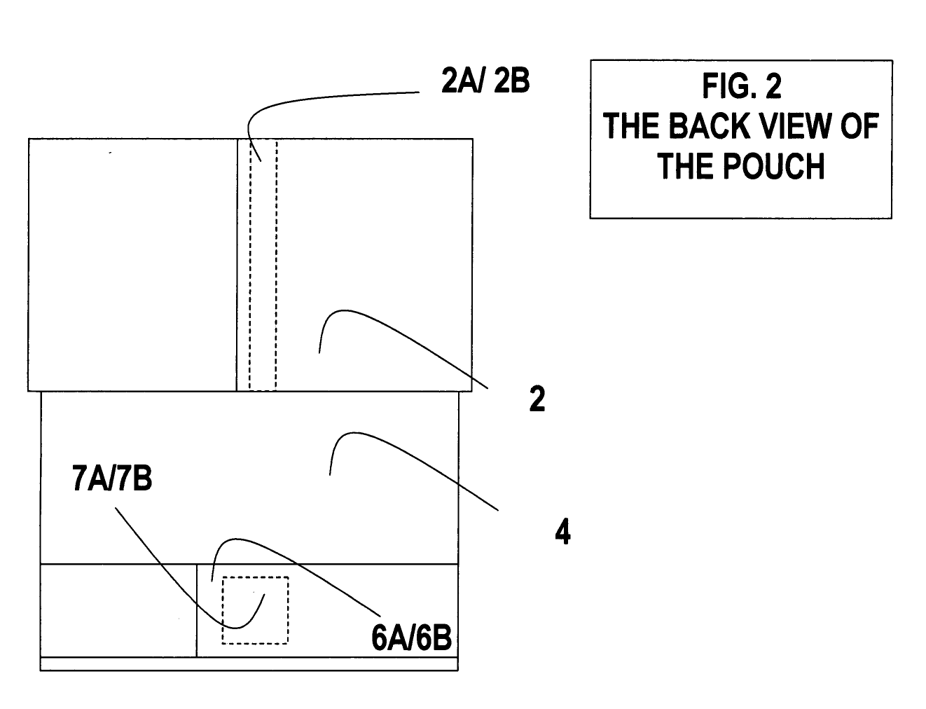

The Function FIG. 1

1. The pouch has a compartment with an opening at the top which stores a notebook, notepad, or a note tablet

2. The sleeve wraps around the front cover of a Bible or any text book.

2A./2B. The material that acts as a sleeve overlap for the purpose of connecting the Velcro material in place.

3. The fold-over flap overlaps to close the opening of the pouch. The flap is secured in place by a metal snap button or Velcro.

4 An extended piece of material is attached to the bottom of the pouch. It wraps around the spine to the back cover about 1½″. Or (depending on the side of the Bible and Book) the extended piece of material is positioned between the pouch and the sleeve.

5 A metal snap button is used to secure the flap in place.

6A/6B. Two straps are positioned at the bottom of the extended piece of material. One strap is on the right side, and the other strap is on the left side.

7A./7B. Velcro material is placed on the ends of the straps. When the Velcro strips meet the straps are held in place. The straps wrap around the inside cover of the back of the Bible or book.

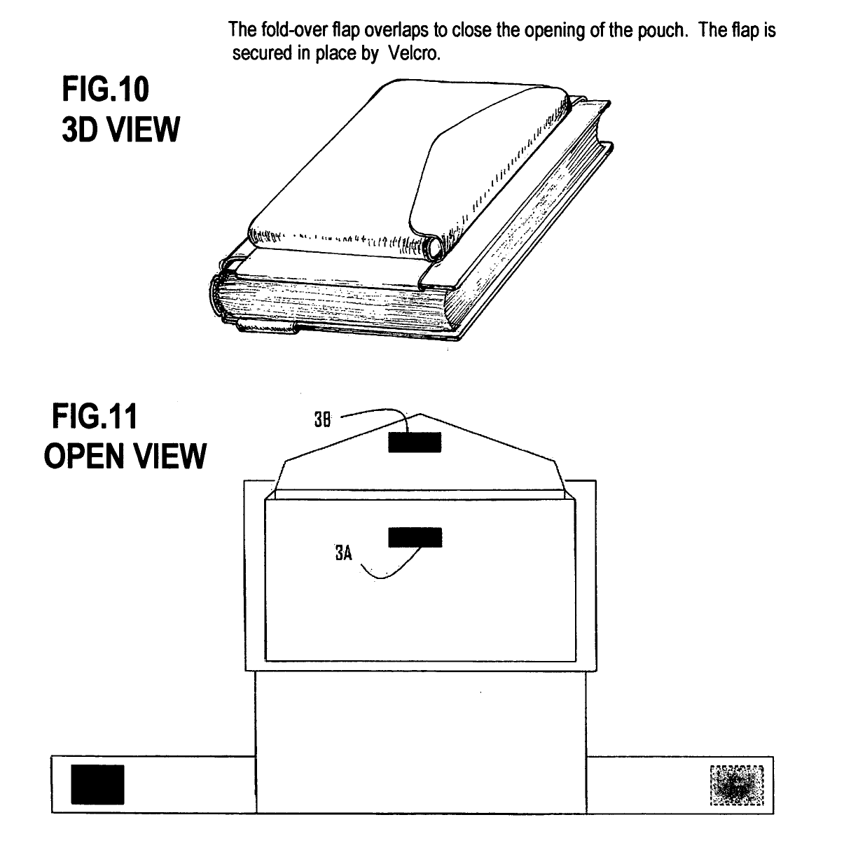

The Function FIG. 11

3A/3B The fold-over flap overlaps to close the opening of the pouch. The flap is secured in place by Velcro.

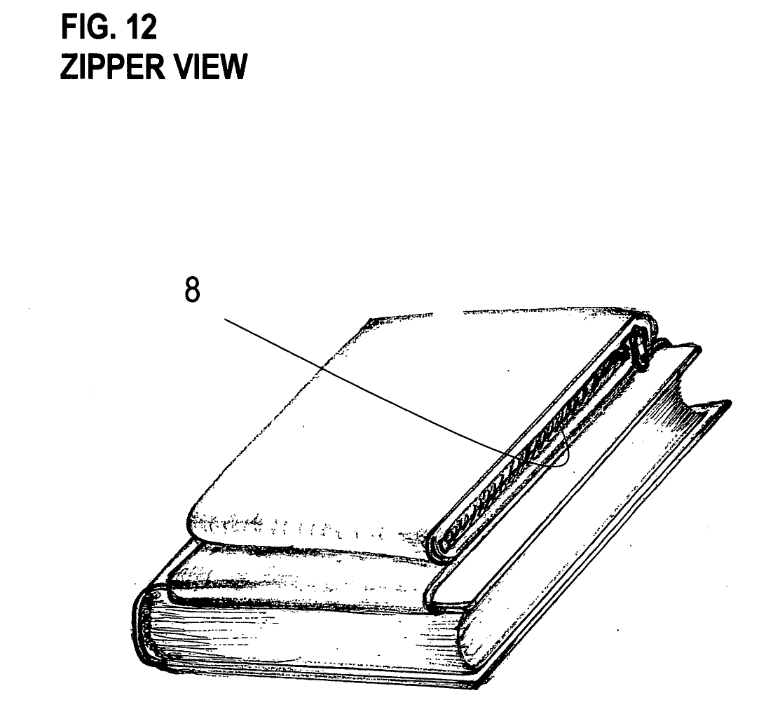

The Function FIG. 12

8 Metal or plastic zippers are used to close the pouch.

The Material

The pouch is made from all different kinds of fabrics and colors.

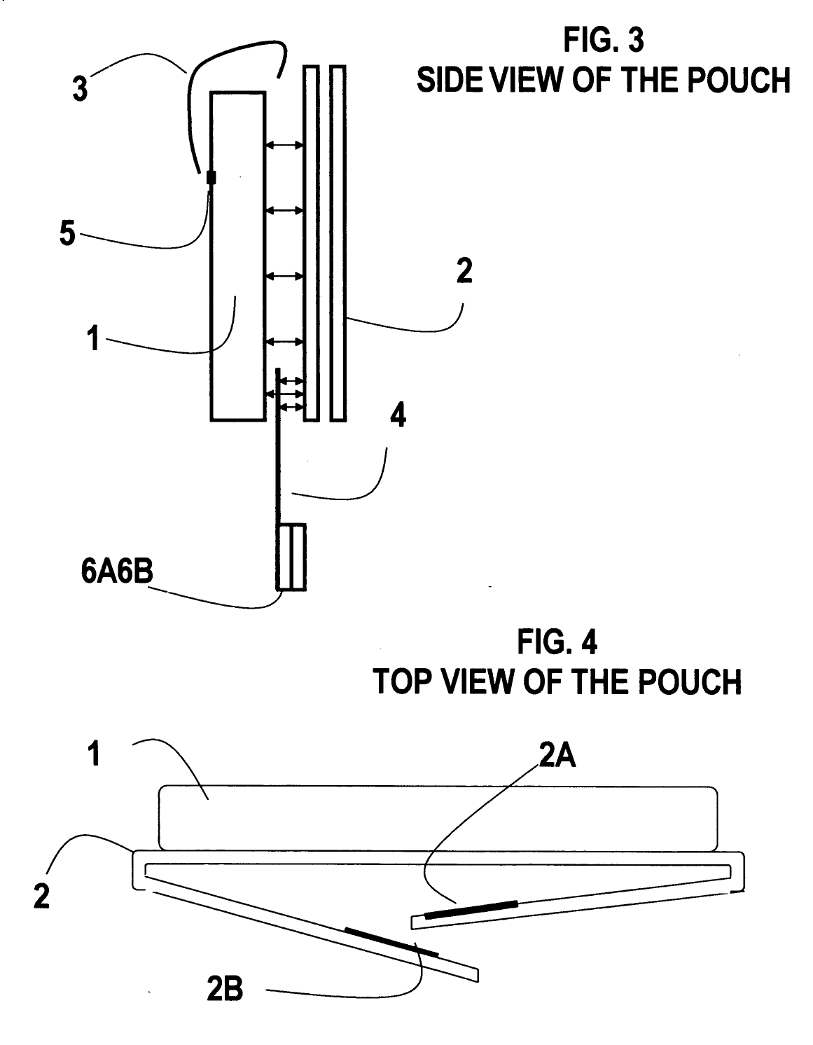

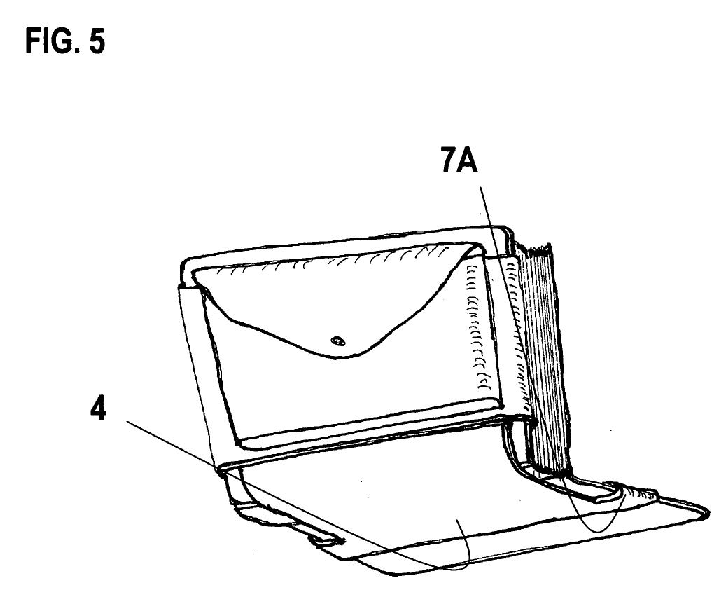

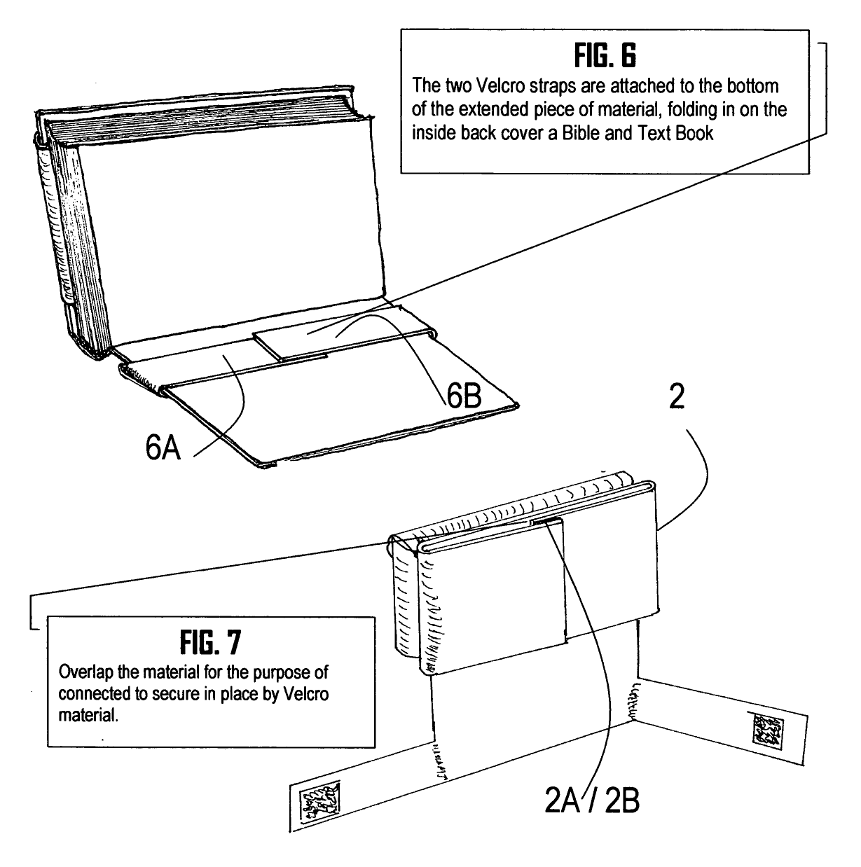

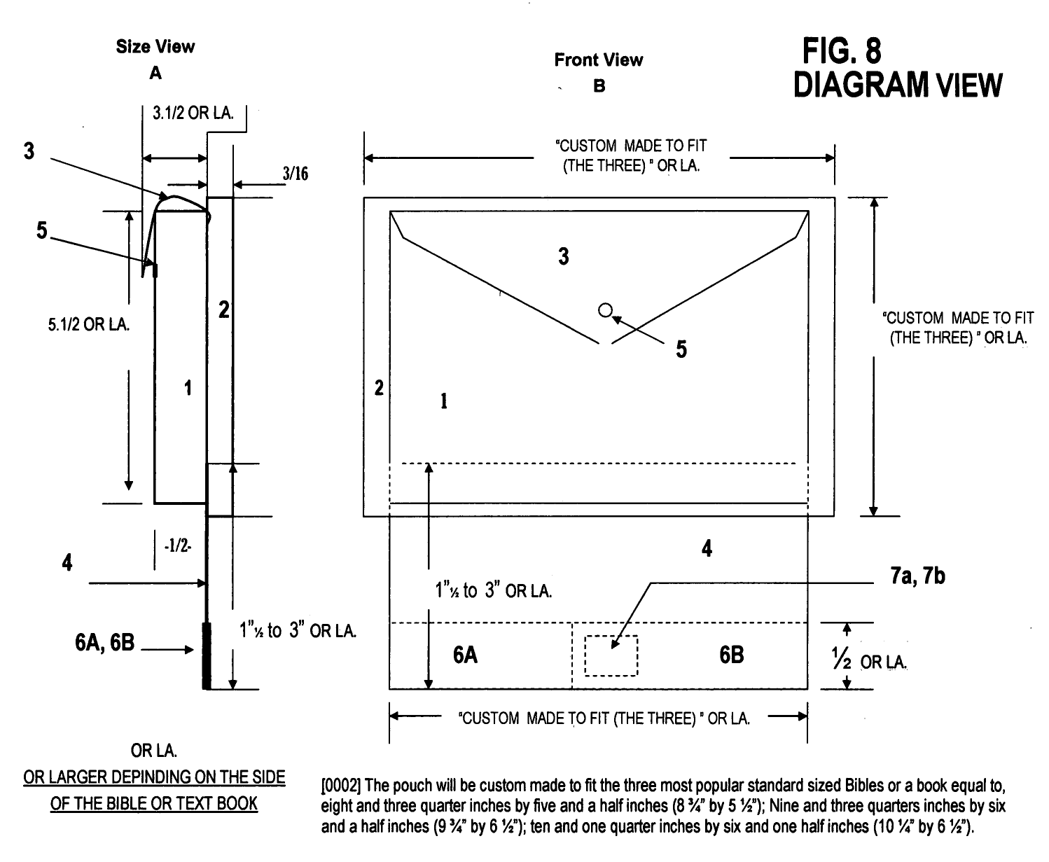

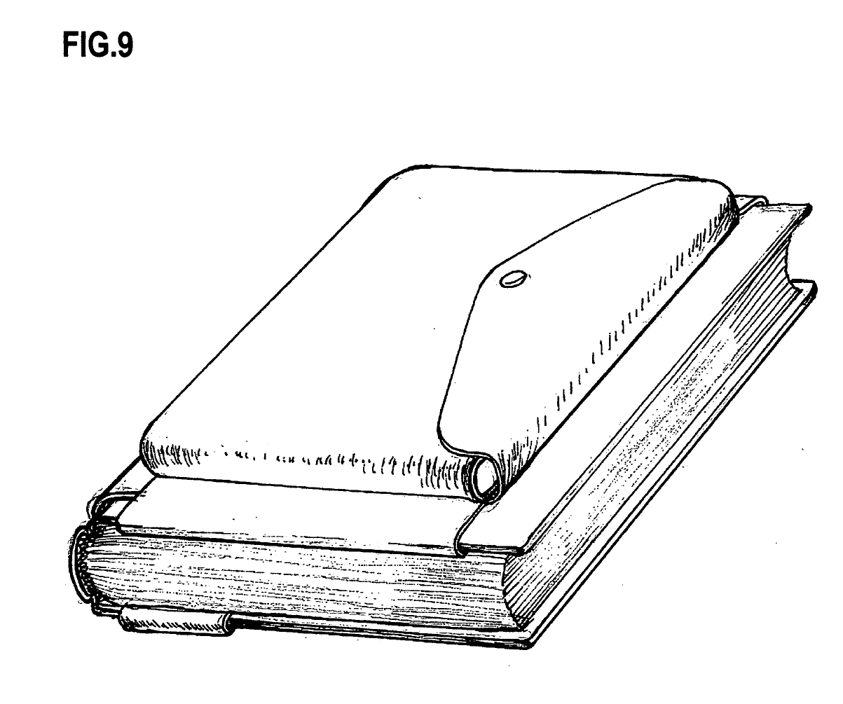

1. This invention relates to a pouch comprising of a method for joining yard goods and materials together to provide storage for materials related to; drawing on a smooth surface, sketching record keeping product that is generate from teaching lectures, and record study notes from a book. The usual operation for this type of pouch, is for securing and transporting said products as it relates to the invention while being attach to a Bible. This is intended to enable the student to comfortably and conveniently transport counseled study notes at the same time. The said invention comprise of a rift at the top, with an upper member at the top positioned as a means for imbricate the rift. The intent is to close the rift which counsels and secures said product in place. The upper member can be joined together with (1) a metal snap button (2) Velcro material (3) a plastic zipper at the top of the rift; thus this counsels and secures said product in place. The invention is based on a means for attaching to a book, comprising of a member that is position on the back of said pouch, comprising of a method for joining material whereof together as it relate to the design of the said invention, with the intent of attaching said pouch to said member. The attached member of the said pouch is design to pull open to lay flat on to the front cover of a book with the book in the close horizontal position. The intent is to lift the front cover of said book in the upright position, for the propose of wrapping the said member of the pouch around to the reverse side of the front cover to imbricate the member for the purpose of connecting together with Velcro material. Position both ends of said member as it relates to the design of the invention, with the intent of securing and attaching the invention to said Bible. Once the member thereof is fitted on to the front cover, it can be pulled off the front cover for the means of sliding it off and on. The member whereof, acts as a sleeve which slides onto the front cover. The invention has an extended piece of material relating to the design of the invention positioned at the bottom of the invention, sandwiched between the pouch and the attach member that acts as a sleeve. This extended piece of material is design to wrap around the spine to the back cover of said book up to about 1½″ from the base of the book depending on the size of the book. At the end of this extended piece of material are two straps of material design to wrap around to the inside of the back and are connected with Velcro. The invention is described in detail hereinafter with the aid of the accompanying Figures which illustrate one embodiment thereof by way of non-limiting examples. FIG. 1 is the vertical front view of the first embodiment of the upper member position at the top (3) of FIG. 1. The upper member is design to be an imbricate device as a means to cover the rift of the invention. The device lifts up to clear the way for products relating to a flat smooth horizontal surface, products that provide a source for drawing on a smooth surface, sketching, record keeping products generated from a persons teaching and or lecturing. The said product is to be placed inside (1) of FIG. 1 indicating to be the pouch, (2) of FIG. 1 the attached member of the said pouch is design to pull open to lay flat on to the front FIGS. 6 and 7 shown (2) the attached member covering the front cover of a book with the book in the close horizontal position, shown in FIG. 9. The intent is to lift the front cover of said book in the upright position, for the propose of wrapping the said (2) member of the pouch, around to the reverse side of the said front cover to imbricate shown in FIG. 7 the two ends of the attach member for the purpose of connecting 2A and 2B shown FIG. 1 and FIG. 7 together with Velcro material. The invention has an extended piece of material (4) relating to the design shown in FIG. 1 of the invention positioned at the bottom of the invention, sandwiched between the pouch (1) and the attach (2) member that acts as a sleeve. This extended piece of material (4) is design to wrap around the spine, to the back cover of said book up to about 1½″ from the base of the book depending on the size of the book. At the end of this extended piece of material are two (6A and 6B) straps of material design to wrap around to the inside of the back and are connected with (7A and 7B) Velcro material.
